(19) United States
(12) Patent Application Publication
(10) Pub. No.: US 2018/0310627 A1
(43) Pub. Date: Nov. 1, 2018

(54) ATOMIZING HEAD, ATOMIZER, AND ELECTRONIC CIGARETTE

(71) Applicant: CHANGZHOU JWEI INTELLIGENT TECHNOLOGY CO., LTD., Changzhou (CN)

(72) Inventor: Weihua QIU, Changzhou (CN)

(21) Appl. No.: 16/027,957

(22) Filed: Jul. 5, 2018

Related U.S. Application Data
(63) Continuation-in-part of application No. PCT/CN2017/082807, filed on May 3, 2017.

(30) Foreign Application Priority Data
May 6, 2016 (CN) 201610298950.6
May 6, 2016 (CN) 201610299431.1

(51) Int. Cl. A24F 47/00; A24F 7/00; H05B 3/24

(52) U.S. Cl. CPC A24F 47/008; H05B 3/24; A24F 7/00

(57) ABSTRACT

A atomizing head includes a main body seat and a heating member. The main body seat includes a cylindrical portion. The cylindrical portion defines a pair of slots on opposite sides of the cylindrical portion. The heating sheet is installed in the cylindrical portion and is clamped in the pair of slots, the heating sheet divides the cylindrical portion into two first atomizing spaces which are opposite to each other. An atomizer has the atomizing head is installed in an electronic cigarette.

### CROSS-REFERENCE TO RELATED APPLICATIONS

The instant application is a continuation-in-part of international application No. PCT/CN2017/082807 filed on May 3, 2017, and claims priority to Chine patent application Nos. 201610299431.1 and 201610298950.6 filed on May 6, 2016, and the entire contents of these applications are hereby incorporated by reference.

### FIELD OF TECHNOLOGY

The invention relates to a technical field of electronic cigarettes, and more particularly, relates to an atomizing head, an atomizer having the atomizing head, and an electronic cigarette having the atomizer.

### BACKGROUND

At present, the electronic cigarette is a mature alternative for cigarette in the market. A battery supplies power for a heating unit in the atomizing head, the heating unit is electrically driven to heat tobacco liquid to generate smog, for user to obtain a smoke experience.

However, the heating unit of the related atomizing head generally adopts a metallic heating filament, the metallic heating filament is winded to form an annular heating filament and wraps cotton or is wrapped by cotton, and then the annular heating filament is positioned in an atomizing chamber of the atomizing head. An airway in the atomizing chamber for inhale airflow has a particular structure, results in a poor circulation. The inhale airflow passing through the airway cannot bypass the heating unit thoroughly, thereby affecting the user's smoking flavor.

### SUMMARY

Accordingly, it is necessary to provide an atomizing head which allows airflow to flow fluently and avoids an influence to the smoke flavor, an atomizer having the atomizing head, and an electronic cigarette having the atomizer.

An atomizing head, includes a main body seat and a heating member. The main body seat includes a cylindrical portion defining a pair of slots on opposite sides of the cylindrical portion. The heating member includes a heating sheet. The heating sheet is installed in the cylindrical portion and is clamped in the pair of slots, the heating sheet divides the cylindrical portion into two first atomizing spaces which are opposite to each other.

According to an embodiment, the atomizing head includes an external sleeve, wherein the external sleeve is sleeved on a periphery of the cylindrical tube, a tubular wall of the external sleeve tube defines a liquid hole, and a gap is formed between an inner peripheral surface of the external sleeve and a circumferential surface of the cylindrical portion, the tobacco liquid flows through the liquid hole and enters into the gap.

According to an embodiment, the heating sheet is a ceramic heating sheet, the heating sheet is wrapped by a liquid absorbing member and is then clamped by and installed in the cylindrical portion, the liquid absorbing member extends to the gap from the pair of slots on opposite sides of the cylindrical portion.

According to an embodiment, the atomizing head includes an electrode conductor and an insulator, wherein the main body seat further includes a bottom wall and a tubular portion, the bottom wall is formed on a lower end of the cylindrical portion, the tubular portion is formed an end of the bottom wall away from the cylindrical portion, the tubular portion extends through the bottom wall and fluidly communicates with the cylindrical portion, and the heating sheet further includes two leading pins connected to the heating sheet, the electrode conductor is installed in the tubular portion, and is insulated from a tubular wall of the tubular portion via the insulator ring, one of the two leading pins is electrically connected to the electrode conductor, another one of the two leading pins is electrically connected to the tubular wall of the tubular portion.

The present disclosure provides an atomizer having an aforementioned atomizing head.

According to an embodiment, the atomizer includes an airflow regulating assembly, wherein the airflow regulating assembly includes a ventilation tube and an isolator sheet installed in the ventilation tube, the isolator sheet divides the ventilation tube into two second atomizing spaces, an upper end of the ventilation tube defines an intake hole, a lower end of the ventilation tube is aligned to the cylindrical portion of the main body seat, the two second atomizing spaces fluidly communicate with two corresponding first atomizing spaces respectively to form two airflow passages, the two first atomizing spaces are located beneath the two second atomizing spaces, and the two airflow passages fluidly communicate with each other at a lower end of the heating sheet, one of the two airflow passages fluidly communicates with the intake hole, and is closed at an upper end thereof, such that when airflow enters the intake hole, the airflow flows through the airflow passage on a side, and bypasses the heating sheet, and then flows out from an upper end of the conductive space on an opposite side.

According to an embodiment, the airflow regulating assembly further includes a rotation ring, an end of the rotation ring is connected to the ventilation tube, an opposite end of the rotation ring is detachably connected to the atomizing head.

According to an embodiment, the atomizer further includes a mouth piece connector which is connected to an upper end of the ventilation tube, wherein a lower surface of the mouth piece connector defines a sleeve hole which is sleeved on the upper end of ventilation tube, a center of an upper surface of the mouth piece connector defines a smog guiding hole which is fluidly communicated with the sleeve hole.

According to an embodiment, the airflow regulating assembly further includes an airflow regulating structure, the airflow regulating structure includes an inner annular seat and an airflow regulating ring, the inner annular seat includes an annular wall, the annular wall defines an annular groove at a middle portion of an inner peripheral surface thereof to fluidly communicate with the intake hole, the annular wall defines a plurality of ventilation holes at a circumferential surface thereof which are fluidly communicated with the annular groove, and the airflow regulating ring is rotatably sleeved on the inner annular seat, a peripheral wall of the airflow regulating ring defines an intake cutout, when the airflow regulating ring is rotated, a communication area between the intake cutout and the ventilation hole is adjusted.

According to an embodiment, the airflow regulating structure further includes an inner connector, the annular wall defines lower threads at a lower end of a circumferential surface of the annular wall, the inner surface of the inner connector defines threads engaging the lower threads.

The present disclosure provides an electronic cigarette which includes an aforementioned atomizer, and a battery assembly disposed about a lower end of the atomizer.

An atomizer includes an atomizing assembly and a ventilation assembly; wherein the atomizing assembly includes an atomizing seat and a heating assembly, the heating assembly includes a heating sheet clamped by the atomizing seat, the ventilation assembly includes a ventilation tube and a blocking plate, the ventilation tube is sleeved on the atomizing seat and the heating sheet, the blocking plate is connected to an upper end of the heating sheet to cooperatively divide the ventilation tube into two conductive spaces which are fluidly communicated with each other at a lower end of the heating sheet, the ventilation tube defines an intake hole at a tubular wall thereof fluidly communicating with one of the two conductive spaces which is sealed at an upper end, such that, airflow enters one of the two conductive spaces at a side of the ventilation tube via the intake hole, and bypasses the heating sheet, and then the airflow flows out from the upper end of the conductive space on an opposite side.

According to an embodiment, the atomizing seat defines a first clamping groove along an axial direction of the atomizing seat, and forms a pair of clamping peripheral walls accordingly, the pair of clamping peripheral walls is opposite to each other, the heating assembly further includes a liquid absorbing member wrapping the heating sheet, the heating sheet along with the liquid absorbing member are clamped by and installed in the first clamping groove, and extend outwardly from the first clamping groove.

According to an embodiment, the ventilation tube defines a second clamping groove along an axial direction of the ventilation tube, for clamping the heating sheet which is wrapped by the liquid absorbing member and extends out from the first clamping groove.

According to an embodiment, the heating assembly further includes two conductive pins connected to a lower end of the heating sheet, the heating sheet and the two clamping peripheral walls form two oriented gaps, each oriented gap is formed between the heating sheet and one of the two clamping peripheral walls, the conductive pin allows airflow to flow there-through, causing the two oriented gaps on opposite sides of the heating sheet to fluidly communicate with each other, the oriented gap is received in corresponding conductive space, causing the two conductive spaces on opposite sides of the heating sheet to fluidly communicate with each other at the lower end of the heating sheet.

According to an embodiment, the ventilation assembly further includes an upper cover disposed about the upper end of the ventilation tube, a lower surface of the upper cover defines a sleeve hole which is sleeved on the upper end of the ventilation tube, a center of an upper surface of the upper cover defines a smog guiding hole fluidly communicated with the sleeve hole.

According to an embodiment, the ventilation assembly includes an airflow regulating structure, the airflow regulating structure includes an inner annular seat and an airflow regulating ring, the airflow regulating ring is movably sleeved on a circumference of the inner annular seat, the inner annular seat includes an annular wall, the annular wall defines an annular groove at a middle portion of an inner peripheral surface thereof to fluidly communicate with the intake hole, the annular wall defines a plurality of ventilation holes at a circumferential surface thereof, the plurality of ventilation holes fluidly communicate with the annular groove, a peripheral wall of the airflow regulating ring defines an intake cutout, when the airflow regulating ring is rotated, a communication area between the intake cutout and the ventilation hole is adjusted.

According to an embodiment, an end of the atomizing seat away from the heating sheet is a connecting end, the connecting end includes a cylindrical tubular portion, an upper peripheral flank, and a lower peripheral flank, the upper peripheral flank and the lower peripheral flank are formed on a periphery of the cylindrical tubular portion and are spaced from each other, a lateral length of the lower peripheral flank is greater than a lateral length of the upper peripheral flank, the atomizing assembly further includes a connector, the connector includes a cover bottom plate and a cover peripheral wall formed on a periphery of the cover bottom plate, the cover bottom plate defines a perforation on a center thereof, the connector extends through the perforation upwardly and is sleeved on the connecting end, an assembly gap is formed between an inner side of the cover peripheral wall and an upper side of the upper peripheral flank, for assembling the ventilation tube.

According to an embodiment, a silica gel pad is positioned to seal the upper end of the conductive space which fluidly communicates with the intake hole.

According to an embodiment, the heating sheet is a ceramic heating sheet.

The present disclosure disclose an electronic cigarette which includes an aforementioned atomizer and a battery assembly disposed about a lower end of the atomizer.

The preferred technical solution and advantages of the present disclosure is specifically illustrated with reference to the following embodiment.

Compared to the related technical solution, in the atomizing head, the atomizer having the atomizing head, and the electronic cigarette having the atomizer of the present disclosure, the heating sheet is positioned on the lower end of the ventilation tube, the heating sheet is installed in the cylindrical portion and is clamped in the pair of slots, the heating sheet divides the cylindrical portion into two first atomizing spaces which are opposite to each other, causing the inhale airflow to bypass the heating sheet thoroughly, the inhale airflow flows fluently, and the smoking flavor cannot be affected.

Compared to the related technical solution, in the atomizer of the present disclosure, the heating sheet is positioned on the lower end of the ventilation tube, causing the inhale airflow to bypass the heating sheet thoroughly, the inhale airflow flows fluently, and the smoking flavor cannot be affected. Further, by adopting the ceramic heating sheet to replace the related metallic winding heating filament, the situation of the peculiar smell generated by a dry-ashing of the metallic filament can be avoided.

The preferred technical solution and advantages of the present disclosure is specifically illustrated with reference to the following embodiment.

### BRIEF DESCRIPTION OF THE DRAWINGS

The invention is specifically illustrated with reference to accompanying drawings and embodiments in the following description.

FIG. 1 is an isometric view of an atomizer according to an embodiment of the present disclosure;

FIG. 2 is an exploded view of the atomizer of FIG. 1;

FIG. 3 a cross-sectional view of the atomizer of FIG. 1;

FIG. 4 is an atomizing head of an atomizer of the present disclosure;

FIG. 5 is an exploded view of the atomizing head of FIG. 4;

FIG. 6 a cross-sectional view of the atomizing head of FIG. 4;

FIG. 7 an isometric view of an atomizer according to another embodiment of the present disclosure;

FIG. 8 is an exploded view of the atomizer of FIG. 7;

FIG. 9 is a cross-sectional view of the atomizer of FIG. 7, taken along line A-A;

FIG. 10 is an isometric view of the atomizer of FIG. 7, viewed from another aspect; and

FIG. 11 is a cross-sectional view of the atomizer of FIG. 10, taken along line B-B.

### DETAILED DESCRIPTION OF THE PREFERRED EMBODIMENT

Technical solutions in the embodiments of the present application will be described clearly and thoroughly hereinafter with reference to the accompanying drawings. Apparently, the embodiments described herein are merely parts of but not exclusive embodiments of the present application. All alternative embodiments obtained by those skilled in the art based on the embodiments of the present application without creative works shall fall within the protection scope of the present application.

### The First Embodiment

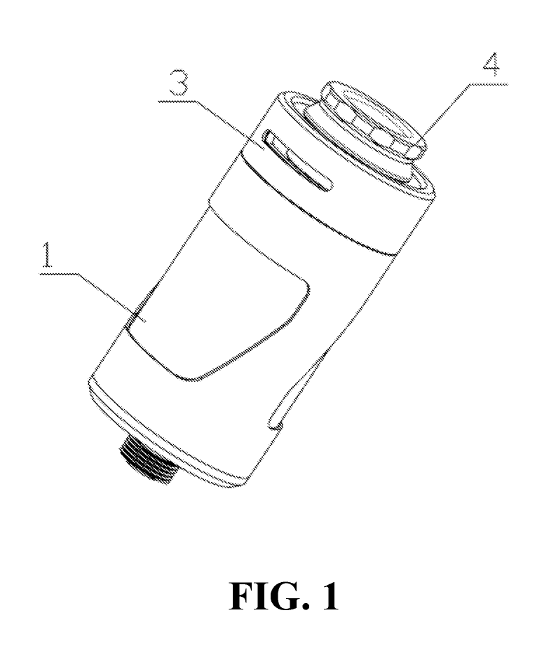

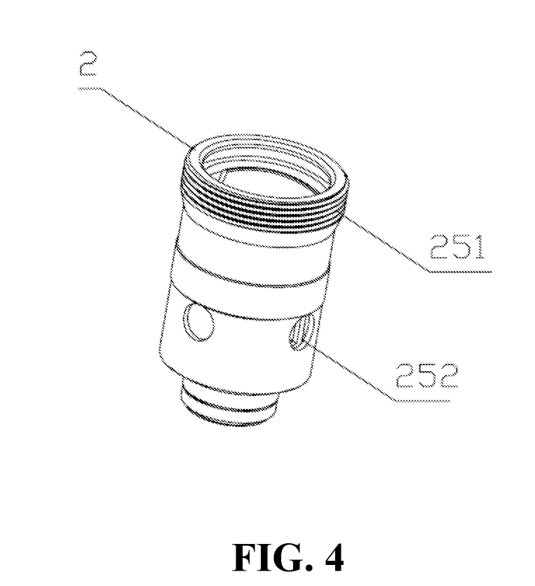

Referring to FIG. 1 and FIG. 4, the present disclosure provides an atomizer for an electronic cigarette, the atomizer includes a liquid storage assembly 1, an atomizing head 2, an airflow regulating assembly 3, and a mouth piece connector 4. The atomizing head 2 is installed in the liquid storage assembly 1, the airflow regulating assembly 3 is disposed about an upper end of the liquid storage assembly 1 and engages the mouth piece connector 4.

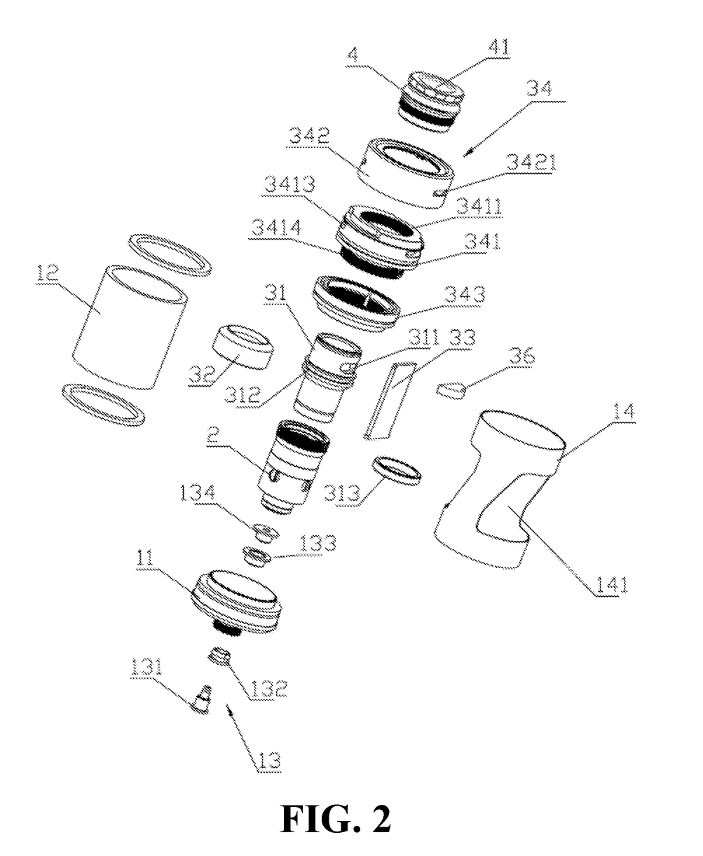

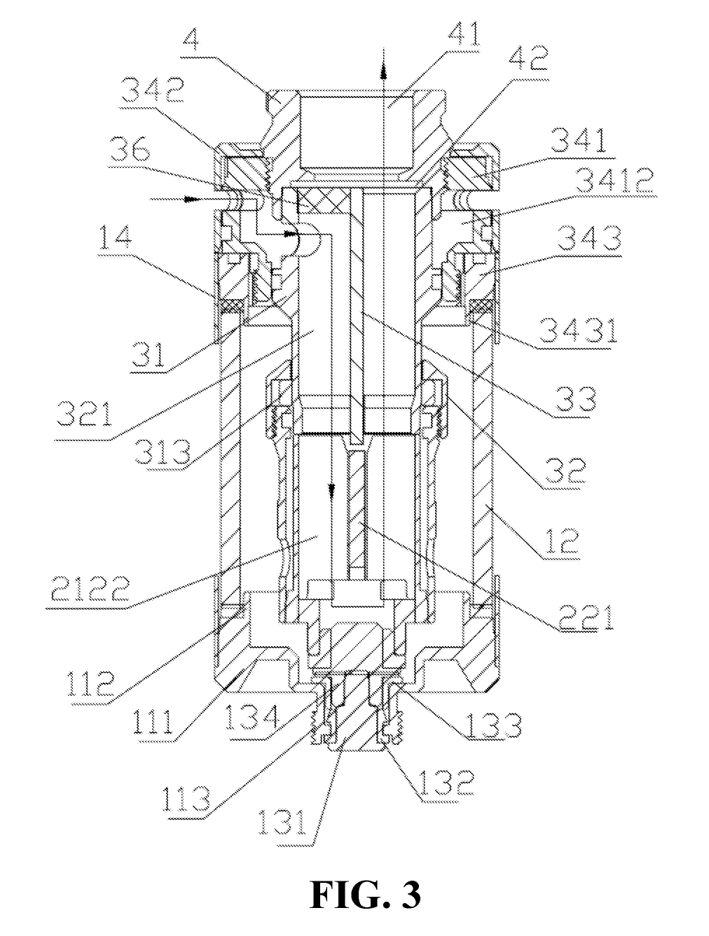

Referring to FIG. 2 and FIG. 3, the liquid storage assembly 1 includes a lower cover 11, a liquid storage tube 12, and an electrode contacting assembly 13. The lower cover 11 includes a cover bottom plate 111, the cover bottom plate 111 is provided with a protrusion ring 112 protruding from a periphery of the cover bottom plate 111. Accordingly, a stepped groove is formed between a periphery of the protrusion ring 112 and an upper surface of cover bottom plate 111. The cover bottom plate 111 is provided with a cylindrical tube 113 protruding from a center of a lower surface of the cover bottom plate 111. The cylindrical tube 113 is provided with external threads at a peripheral wall of the cylindrical tube 113. The cover bottom plate 111 defines a receiving chamber on a center of the upper surface of the cover bottom plate 111. The cylindrical tube 113 fluidly communicates with the receiving chamber. The liquid storage tube 12 is disposed about an upper end of the lower cover 11, and a lower end of the liquid storage tube 12 is sleeved on a periphery of the protrusion ring 112. The liquid storage tube 12 is a transparent tube made from materials such as glass and so on, facilitating for user to observe a residual amount of the tobacco liquid in the liquid storage tube 12. The liquid storage tube 12 can also be made from other translucent material which facilitates for user to observe a residual amount of the tobacco liquid in the liquid storage tube 12. The electrode contacting assembly 13 is installed in the cylindrical tube 113 of the cover bottom plate 111, for electrically connected to the atomizing head 2. The electrode contacting assembly 13 includes a first anode contacting member 131, a first insulating ring 132, a second anode contacting member 134 and a second insulating ring 133. The first anode contacting member 131 is installed in the lower end of the cylindrical tube 113, and is insulated from the cylindrical tube 113 via the first insulating ring 132. The second anode contacting member 134 is installed in the upper end of the cylindrical tube 113, and is insulated from the cylindrical tube 113 via the second insulating ring 133. The upper end of the second anode contacting member 134 is electrically connected to the atomizing head 2, the lower end of the second anode contacting member 134 is electrically connected to the first anode contacting member 131. At the same time, the second insulating ring 133 can be made of silica gel pad, and is configured to improve a sealing function, preventing a leakage of the tobacco liquid. The liquid storage assembly 1 further includes a protective cover 14. The protective cover 14 is sleeved on a periphery of the liquid storage tube 12, to protect the liquid storage tube 12 from being damaged. When the protective cover 14 is installed, the periphery of the cover bottom plate 111 can define a stepped cutout for supporting the protective cover 14, thereby assembling the protective cover 14 to the periphery of the liquid storage tube 12, and the protective cover 14 closely contacts the liquid storage tube 12. The protective cover 14 can be made of hard materials and can be a steel tube or a copper tube. The protective cover 14 defines an observe window 141 at a circumferential surface of the protective cover 14, facilitating for user to observe a residual amount of the tobacco liquid in the liquid storage tube 12.

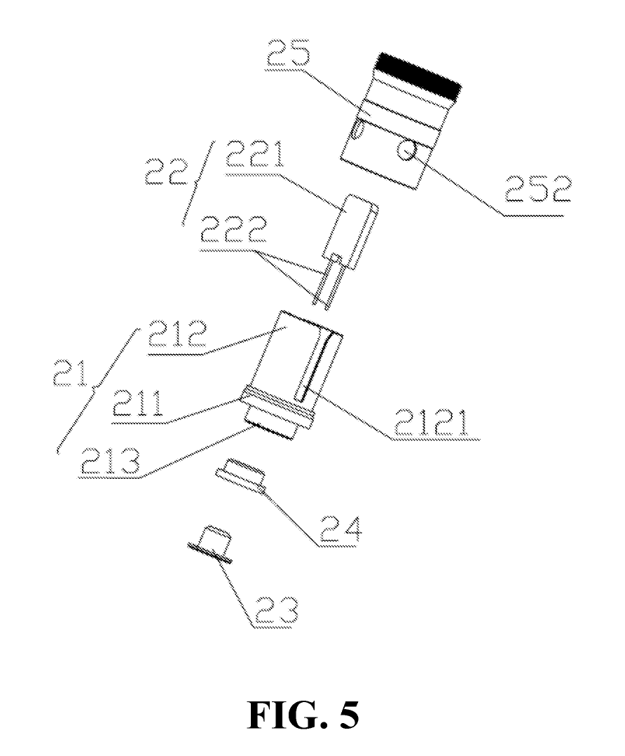

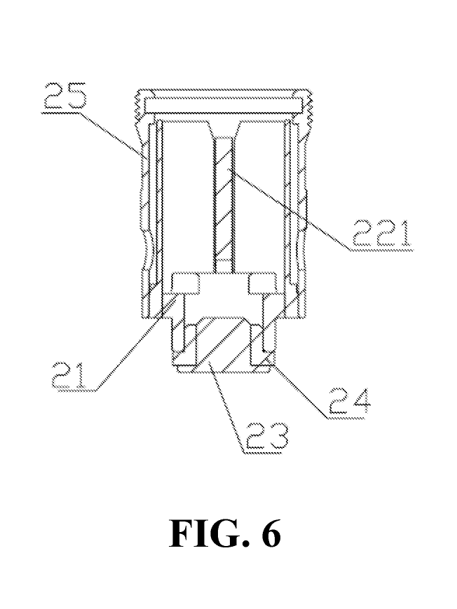

Referring to FIG. 5 and FIG. 6, the present disclosure provides an atomizing head 2. The atomizing head 2 includes a main body seat 21, a heating member 22, an electrode conductor 23, an insulator ring 24, and an external sleeve 25. The main body seat 21 includes a bottom wall 211, a cylindrical portion 212 and a tubular portion 213. The cylindrical portion 212 is formed on the upper end of the bottom wall 211, the tubular portion 213 is formed on the lower end of the bottom wall 211 and fluidly communicates with the cylindrical portion 212. The cylindrical portion 212 defines a pair of slots 2121 on the peripheral wall of the cylindrical portion 212. The heating member 22 includes a heating sheet 221 and two leading pins 222 connected to the heating sheet 221. The heating sheet 221 is clamped in the pair of slots 2121 and is attached to the cylindrical portion 212. The heating sheet 221 divides the cylindrical portion 212 into two first atomizing space 2122. The heating sheet 221 divides the cylindrical portion 212 into two first atomizing space 2122. The electrode conductor 23 is resisted in the tubular portion 213, and is insulated from the tubular wall of the tubular portion 213 via the insulator ring 24. The electrode conductor 23 engages the insulator ring 24 to secure the two leading pins 222 of the heating member 22, causing one leading pin 222 to electrically connect the electrode conductor 23, another leading pin 222 to electrically connect a sidewall of the tubular portion 213. The external sleeve 25 is fixedly sleeved on the main body seat 21, configured to connect the main body seat 21 to the airflow regulating assembly 3. According to the illustrated embodiment, after the external sleeve 25 is sleeved on the main body seat 21, a gap is formed between an inner peripheral surface of the external sleeve 25 and a circumferential surface of the cylindrical portion 212. Specifically, an external diameter of the cylindrical portion 212 of the main body seat 21 is less than an external diameter of the bottom wall 211. The external diameter of the bottom wall 211 is equal to an internal diameter of the external sleeve 25. The lower end of the external sleeve 25 engages the bottom wall 211 by an interference fit. A circumferential surface of the upper end of the external sleeve 25 forms external threads 251. The external sleeve 25 defines a liquid hole 252 at a sidewall of the external sleeve 25, for the tobacco liquid to flow into the gap between the inner surface of the external sleeve 25 and the circumferential surface of the cylindrical portion 212 of the main body seat 21. The heating sheet 221 has a rectangular structure, and is a ceramic heating sheet. When the atomizing head 2 is assembled, the heating sheet 221 is wrapped by a liquid absorbing member (cotton or cotton cloth, not shown) and is vertically fixed in the main body seat 21. The liquid absorbing member (cotton, e.g.) wrapping the heating sheet 221 extends out of the pair of slots 2121 on opposite sides of the main body seat 21, the liquid absorbing member is configured to absorb liquid and transfers the liquid to the heating sheet 221. The two leading pins 222 are fixed by the insulator ring 24 and the electrode conductor 23, thereby achieving a target of fixing the entire heating member 22, and then the external sleeve 25 is sleeved on the main body seat 21, thereby the entire atomizing head 2 is constructed.

Referring to FIG. 2 and FIG. 3, the airflow regulating assembly 3 includes a ventilation tube 31, a rotation ring 32, and an isolator sheet 33. The ventilation tube 31 is assembled in the liquid storage tube 12 and is connected to an upper end of the atomizing head 2. As an alternative embodiment, the inner peripheral wall of the ventilation tube 31 defines two clamping grooves, for clamping the isolator sheet 33, the two clamping grooves are opposite to each other. The ventilation tube 31 defines an intake hole 311 at a side of an upper end of the ventilation tube 31. The rotation ring 32 is configured to connect the ventilation tube 31 to the external sleeve 25 of the atomizing head 2. The rotation ring 32 has an annular section and a taper section formed on an end of the annular section. The annular section has internal threads. The rotation ring 32 connects the ventilation tube 31 to the external sleeve 25. The lower end of the ventilation tube 31 is aligned to the cylindrical portion 212 of the main body seat 21, the internal threads of the annular section of the rotation ring 32 engages the external threads 251 of the external sleeve 25. The taper section of the rotation ring 32 closely contacts and is sleeved on the ventilation tube 31, such that the ventilation tube 31 is fixedly connected to the external sleeve 25. The isolator sheet 33 is installed in the clamping grooves of the ventilation tube 31. After the ventilation tube 31 is connected to the external sleeve 25, the isolator sheet 33 is connected to the upper end of the heating sheet 221 of the atomizing head 2, and is aligned to the heating sheet 221. The isolator sheet 33 divides the ventilation tube 31 into two second atomizing spaces 321. The two second atomizing spaces 321 and the two corresponding first atomizing spaces 2122 form two airflow passages, respectively. The two first atomizing spaces 2122 are located beneath the two second atomizing spaces 321, and the two first atomizing spaces 2122 are positioned on opposite sides of the heating sheet 221. The two airflow passages fluidly communicate with each other at the lower end of the heating sheet 221. One of the two airflow passages is fluidly communicated with the intake hole 311, and is closed at an upper end of the airflow passage. In the illustrated embodiment, a silica gel pad is configured to seal the airflow passage, such that when the airflow enters the intake hole 311, the airflow can only flow through one airflow passage at a side of the ventilation tube 31, and then bypasses the heating sheet 221 to flow out from an upper end of the airflow passage at an opposite side (the airflow direction shown by the arrow in FIG. 3).

The mouth piece connector 4 is attached to the upper end of the ventilation tube 31, the mouth piece connector 4 defines a sleeve hole 42 at a lower surface of the mouth piece connector 4, the sleeve hole 42 is sleeved on the upper end of ventilation tube 31. The mouth piece connector 4 defines a smog guiding hole 41 at a center of an upper surface of the mouth piece connector 4, the smog guiding hole 41 fluidly communicate with the sleeve hole 42. The smog guiding hole 41 is configured to assembly a mouth piece. The mouth piece connector 4 defines threads at a circumferential surface of the mouth piece connector 4.

The airflow regulating assembly 3 further includes an airflow regulating structure 34, the airflow regulating structure 34 includes an inner annular seat 341, an airflow regulating ring 342, and an inner connector 343. The inner annular seat 341 defines a through hole at a center of the inner annular seat 341, and the inner annular seat 241 forms an annular wall correspondingly at an inner side. The annular wall is provided with upper threads 3411 at an upper end of the inner surface of the annular wall, for engaging the threads on the circumferential surface of the mouth piece connector 4. The annular wall defines an annular groove 3412 at a middle portion of the inner surface of the annular wall. The annular groove 3412 fluidly communicates with the intake hole 311. The annular wall defines a plurality of ventilation holes 3413 at a circumferential surface thereof fluidly communicating with the annular groove 3412. The annular wall defines lower threads 3414 at a lower end of the circumferential surface of the annular wall. The airflow regulating ring 342 is rotatably sleeved on the inner annular seat 341. The airflow regulating ring 342 defines an intake cutout 3421 at a peripheral wall of the airflow regulating ring 342. When the airflow regulating ring 342 is rotated, a communication area between the intake cutout 3421 of the airflow regulating ring 342 and the ventilation hole 3413 of the inner annular seat 341 is changed, thereby an air inflow can be adjusted. Further, the inner annular seat 341 is provided with a limiting post (not shown) protruding from a circumferential surface of the inner annular seat 341. The limiting post extends through the intake cutout 3421 of the airflow regulating ring 342, such that a rotation route of the airflow regulating ring 342 can be limited. The inner connector 343 is configured to connect the inner annular seat 341 to the upper end of the liquid storage tube 12, for improve the air-tightness of the liquid storage tube 12. Specifically, the inner connector 343 defines a stepped groove at the circumferential surface of the lower end of the inner connector 343, the lower end of the inner connector 343 is provided a protruding flange 3431 at the lower end of the inner connector 343 accordingly. The protruding flange 3431 extends into the liquid storage tube 12. The stepped groove engages the upper end of the liquid storage tube 12 (as shown in the accompanying drawing, a sealing ring is provided at the upper end surface of the liquid storage tube 12 and the stepped groove). The inner surface of the inner connector 343 defines threads, the threads on the inner surface of the inner connector 343 engages the lower threads 3414 on the lower end of the circumferential surface of the inner annular seat 341, such that, by a configuration of the inner connector 343, an air-tightness of the connection between the inner annular seat 341 and the upper end of the liquid storage tube 12 is improved. It can be understood that, the inner connector 343 can be omitted, the inner annular seat 341 is directly connected to the liquid storage tube 12.

After the airflow regulating structure 34 is attached to the upper end of the liquid storage tube 12, the lower end of the through hole of the inner annular seat 341 closely contacts and is sleeved on the upper end of the ventilation tube 31. Specifically, the ventilation tube 31 is provided with a protruding portion 312 protruding from the circumferential wall of the ventilation tube 31, the protruding portion 312 resists the inner wall of the though hole of the inner annular seat 341, at the same time, a fixing ring 313 is clamped between the ventilation tube 31 and the rotation ring 32, thereby enhancing a stability of the ventilation tube 31. The annular groove 3412 of the inner annular seat 341 is aligned to and fluidly communicates with the intake hole 311 of the ventilation tube 31, the smog guiding hole 41 of the mouth piece connector 4 fluidly communicates with the second atomizing space 321 which is located at the upper end of the ventilation tube 31 and is not sealed.

A mouth piece can be assembled in the smog guiding hole 41 of the mouth piece connector 4, when the user sucks the mouth piece, a liquid storage space which is formed between the inner wall of the liquid storage tube 12 and the periphery of the atomizing head 2, between the inner wall of the liquid storage tube 12 and the periphery of the ventilation tube 31 stores the tobacco liquid. The tobacco liquid flows though the liquid hole 252 of the external sleeve 25 of the atomizing head 2, and flows into the gap between the inner circumferential surface of the external sleeve 25 and the circumferential surface of the cylindrical portion 212 of the main body seat 21. The liquid absorbing member on the periphery of the heating sheet 221 contacts the tobacco liquid and contains the tobacco liquid by immersing. The airflow flows into the annular groove 3412 through the communication position between the intake cutout 3421 and the ventilation hole 3413. The airflow flows through the intake hole 311 of the ventilation tube 31 from the annular groove 3412 and enters into the airflow passage at a side, the airflow bypasses the heating sheet 221 and enters into the airflow passage on the opposite side, and then flows into the mouth piece. When smoking, by virtue of rotating the airflow regulating ring 342, the communication area between the intake cutout 3421 of the airflow regulating ring 342 and the ventilation hole 3413 of the inner annular seat 341 is changed, thereby the air inflow is adjusted.

### The Second Embodiment

The present disclosure further provides an atomizing head 2, it can be obtained by a combination of the first embodiment. The atomizing head 2 includes a main body seat 21, a heating member 22, an electrode conductor 23, and an insulator ring 24. The main body seat 21 includes a bottom wall 211, a cylindrical portion 212 and a tubular portion 213. The cylindrical portion 212 is formed on the upper end of the bottom wall 211, the tubular portion 213 is formed on the lower end of the bottom wall 211 and fluidly communicates with the cylindrical portion 212. The peripheral wall of the cylindrical portion 212 defines a pair of slots 2121. The heating member 22 includes a heating sheet 221 and two leading pins 222 connected to the heating sheet 221. The heating sheet 221 is clamped by the pair of slots 2121 and is installed in the cylindrical portion 212. The heating sheet 221 divides the cylindrical portion 212 into two first atomizing space 2122. The electrode conductor 23 is installed in the cylindrical portion 212, and is insulated from the tubular portion 213 via the insulator ring 24. One of the two leading pins 222 is electrically connected to the electrode conductor 23, another one of the two leading pins 222 is electrically connected to the sidewall of the tubular portion 213, the electrode conductor 23 is electrically connected to the upper end of the second anode contacting member 134.

By adopting aforementioned atomizing head 2, the entire atomizing head 2 has a simple structure. The heating sheet 221 is clamped in the pair of slots 2121 of the cylindrical portion 212, thereby facilitating for a fixation of the heating sheet 221, the heating sheet 221 divides the cylindrical portion 212 into two atomizing spaces 2122, causing the inhale airflow to bypass the heating sheet 221 thoroughly when the inhale airflow flows, the inhale airflow flows from the atomizing space 2122 at one side to the atomizing space 2122 at an opposite side, facilitating for the smog generated by the heating sheet 221 to flow out fluently which is driven by the inhale airflow, such that the smoking flavor is better.

Further, the heating sheet in the atomizing head 2 is a ceramic heating sheet, it replaces the related metallic winding heating filament, compared to the metallic heating filament, it is difficult for the ceramic sheet to generate a peculiar smell due to a dry-ashing. When a dry-ashing of the metallic heating filament occurs, a peculiar smell during using can seriously influence the flavor of the user. By adopting the ceramic heating sheet, the situation of the peculiar smell generated by a dry-ashing of the metallic filament can be avoided.

Secondly, compared to the related electrical heating element, the ceramic heating member has advantages such as a stable performance, a prolong service life, a high efficiency, an uniform surface temperature, and a better insulating performance. The ceramic heating member is energy conservation. The ceramic heating member has advantages such as a short thermal response time, a little thermal inertial, and a high heating up velocity. The ceramic heating member has no visible radiation and has a high diverging rate, and is safety and environmental protection, meeting the European Union's environmental requirement (ROHS and WEEE). Due to the advantages of the ceramic heating member, the ceramic heating member cannot be substituted by various kinds of electrical heating filament and the PTC heating member, the ceramic heating member becomes the first choice of the next generation heating member. The ceramic heating sheet is a heating device which causes the entire ceramic panel to be heated by the internal ceramic heating unit after the ceramic heating sheet being powered up, the entire ceramic panel does not have charge and naked light. The ceramic heating sheet is a safety and reliable heating member having a circular or a square external shape. The inner heating unit in the ceramic heating member can has a related heating filament structure, and it can also be formed by printing resistance slurry on a ceramic feedstock (e.g. aluminum oxide), and then is baked under a high temperature, and undergoes an electrode treatment and a leading processing.

Further, the ceramic heating sheet can adopts a porous ceramic as a base, the tobacco liquid in the liquid storage chamber can be absorbed by cotton or cotton cloth and be transferred to the holes of the porous ceramic, the ceramic can store some tobacco liquid, avoiding affecting user's flavor due to a dry-ashing.

Further, the atomizing head 2 and the ventilation tube 31 can be dismantled, which facilitates for entirely replacing the atomizing head 2, the replacement of the atomizing head 2 is easier than the replacement of the heating sheet 221.

It can be understood, in order to improve the air-tightness of the liquid storage tube 12, opposite ends of the liquid storage tube 12 are equipped with silica gel pad (not labeled), when the liquid storage tube 12 is installed.

Furthermore, the present disclosure provides an electronic cigarette having the atomizer. The electronic cigarette includes a battery assembly, the battery assembly is connected to a lower end of the liquid storage assembly 1 and is electrically connected to the electrode contacting assembly 13. When the electronic cigarette is used, the battery assembly supplies power for the atomizer, the user smokes though the mouth piece.

### The Third Embodiment

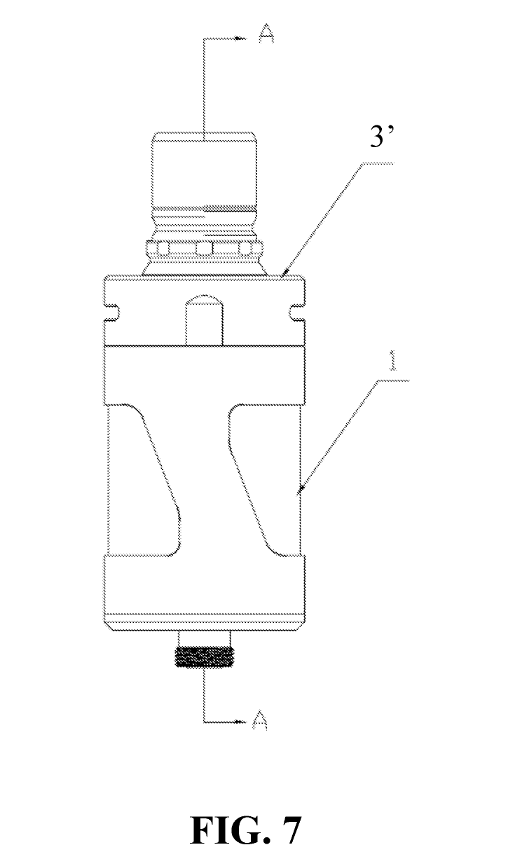

Referring to FIG. 7, an embodiment of the present disclosure provides an atomizer for an electronic cigarette. The atomizer includes a liquid storage assembly 1, an atomizing assembly (not shown), and a ventilation assembly 3′. The atomizing assembly and the ventilation assembly 3′ are assembled together, and are integrally assembled to the liquid storage assembly 1. When the atomizer is dismantled, the atomizing assembly and the ventilation assembly 3′ are integrally separated from the liquid storage assembly 1.

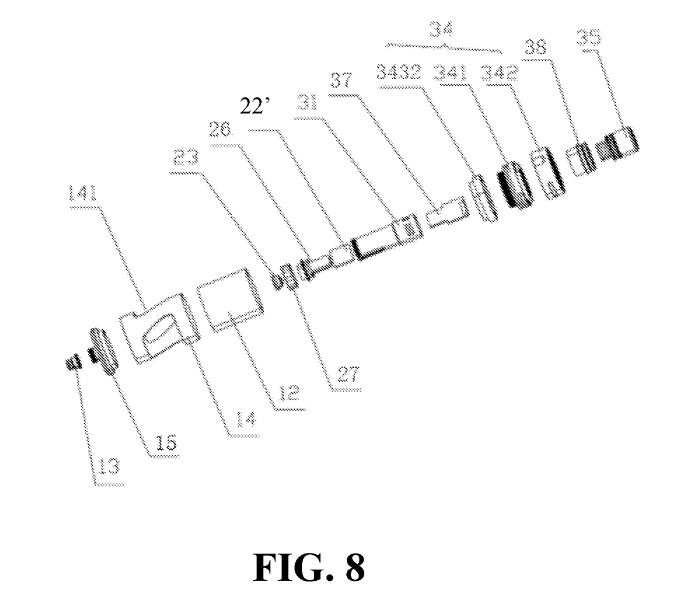

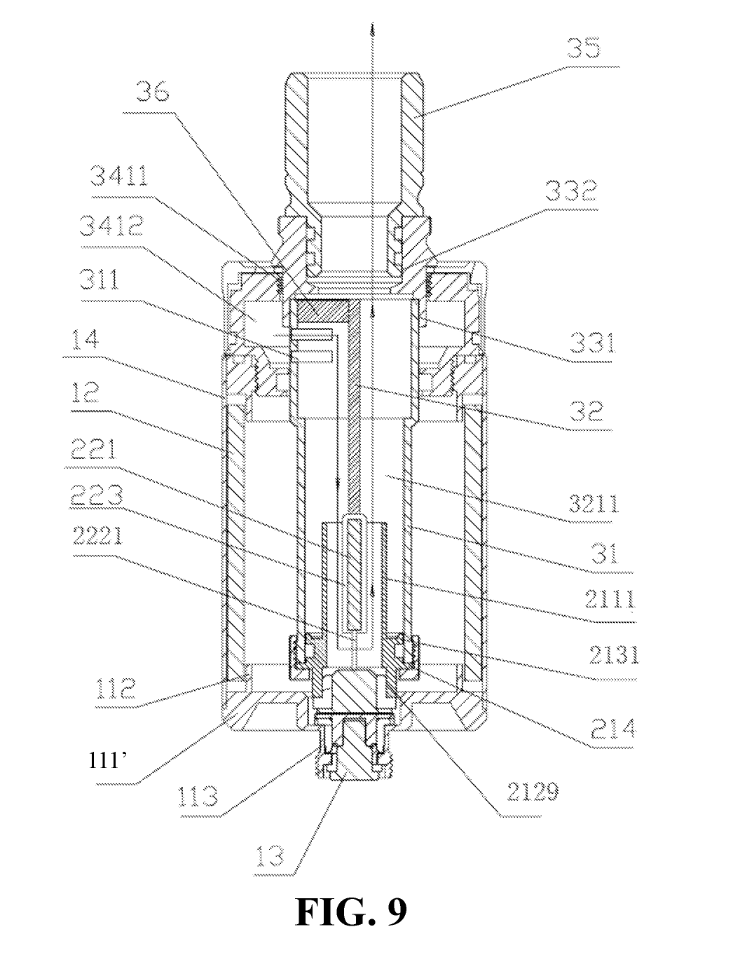

Referring to FIG. 8 and FIG. 9, the liquid storage assembly 1 includes a base seat 15, a liquid storage tube 12, and an electrode contacting assembly 13. The base seat 15 includes a seat bottom plate 111′, the seat bottom plate 111′ is provided with a protrusion ring 112 protruding from a periphery of the seat bottom plate 111′. A stepped groove is formed between the periphery of the protrusion ring 112 and the upper surface of seat bottom plate 111′. The seat bottom plate 111′ is provided with a cylindrical tube 113 protruding from a center of the lower surface of the seat bottom plate 111′. The cylindrical tube 113 is provided with external threads at a peripheral wall of the cylindrical tube 113. The seat bottom plate 111′ defines a receiving chamber on a center of the upper surface of the seat bottom plate 111′. The cylindrical tube 113 is fluidly communicated with the receiving chamber. The liquid storage tube 12 is disposed about the upper end of the base seat 15, the lower end of the liquid storage tube 12 is sleeved on the peripheral of the protrusion ring 112. The liquid storage tube 12 is a transparent tube made from materials such as glass and so on, facilitating for user to observe a residual amount of the tobacco liquid in the liquid storage tube 12. The liquid storage tube 12 can also be made from other translucent material which facilitates for user to observe a residual amount of the tobacco liquid in the liquid storage tube 12. The electrode contacting assembly 13 is installed in the cylindrical tube 113 and is insulated from the cylindrical tube 113 via an insulating member (not labeled). The electrode contacting assembly 13 can serve as an anode and can also serve as a cathode.

The liquid storage assembly 1 further includes a protective cover 14. The protective cover 14 is sleeved on a circumference of the liquid storage tube 12, to protect the liquid storage tube 12 from being damaged. When the protective cover 14 is installed, the periphery of the seat bottom plate 111′ defines a stepped cutout for supporting the protective cover 14, thereby assembling the protective cover 14 to the periphery of the liquid storage tube 12 and the protective cover 14 contacts the liquid storage tube 12. The protective cover 14 can made of hard materials, for example the protective cover 14 is a steel tube or a copper tube. The protective cover 14 defines an observe window 141 at a circumference of the protective cover 14, facilitating for user to observe a residual amount of the tobacco liquid in the liquid storage tube 12.

The atomizing assembly includes an atomizing seat 26, a heating assembly 22′, an electrode conductor 23, and a connector 27. The atomizing seat 26 is attached to a lower end of the liquid storage tube 12, and is connected to the base seat 15. An end of the atomizing seat 26 is a connecting end engaging the base seat 15. An opposite end of the atomizing seat 26 is a clamping end for clamping the heating assembly 22′. The clamping end defines a first clamping groove along an axial direction of the clamping end, and forms a pair of clamping peripheral walls 2111 accordingly. The pair of clamping peripheral walls 2111 is opposite to each other. The heating assembly 22′ includes a heating sheet 221, two leading pins 222 connected to the heating sheet 221, and a liquid absorbing member 223 wrapping the periphery of the heating sheet 221. The heating sheet 221 along with the liquid absorbing member 223 is installed in the first clamping groove, and a portion of the heating sheet 221 extends outwardly from the first clamping groove. The heating sheet 221 and the two clamping peripheral walls 2111 form two oriented gaps, each oriented gap is formed between the heating sheet 221 and one of the two clamping peripheral walls 2111. The two conductive pins 2221 are electrically connected to the electrode conductor 23, the conductive pin 2221 allows the airflow to flow there-through, causing the two oriented gaps on opposite sides of the heating sheet 221 to fluidly communicate with each other. The conductive pin 2221 is an electric conducting pin of the heating sheet 221, one of the two conductive pins 2221 is configured to be connected to an anode, another one of the two conductive pins 2221 is configured to be connected to a cathode. In the illustrated embodiment, one conductive pin 2221 is electrically connected to the electrode conductor 23, another conductive pin 2221 is electrically connected to the cylindrical tube 113 of the base seat 15. The cylindrical tube 113 is a metallic cylinder which is conductive. The electrode conductor 23 is assembled to the connecting end of the atomizing seat 26 and is electrically connected to the electrode contacting assembly 13. In the illustrated embodiment, the electrode conductor 23 serves as an anode contact, i.e. the electrode conductor 23 is connected to the anode of the battery. The connector 27 stably connects the members of the ventilation assembly 3′ to the connecting end of the atomizing seat 26. In the illustrated embodiment, the heating sheet 221 is a ceramic sheet and has a rectangular block shape. The liquid absorbing member 223 is an absorbing cotton, an end of the atomizing seat 26 is a connecting end engaging the base seat 15, the connecting end includes a cylindrical tubular portion 2129, an upper peripheral flank 2131, and a lower peripheral flank 214, the upper peripheral flank 2131 and the lower peripheral flank 214 are formed on the periphery of the cylindrical tubular portion 2129 and are spaced from each other. A lateral length of the lower peripheral flank 214 is greater than that of the upper peripheral flank 2131. An opposite end of the atomizing seat 26 is a clamping end for clamping the heating assembly 22′. The clamping end has a circular shape, the clamping peripheral wall 2111 is an arc-wall. The electrode conductor 23 is installed in the receiving chamber of the seat bottom plate 111′ and extends into the delivery end on the bottom of the cylindrical tubular portion 2129. The electrode conductor 23 is insulated from the inner side of the cylindrical tubular portion 2129 by an insulating member. Specifically, when assembly, the insulating member is sleeved on the periphery of the electrode conductor 23, the connecting end of the cylindrical tubular portion 2129 is sleeved on the periphery of the insulating member. The connector 27 is an annular cover, includes a cover bottom plate and a cover peripheral wall formed on a periphery of the cover bottom plate, the cover bottom plate defines a perforation on a center of the cover bottom plate, the cover peripheral wall defines internal threads on the inner side of the cover peripheral wall. The connector 27 extends through the perforation upwardly and is sleeved on the connecting end of the atomizing seat 26. The lower peripheral flank 214 resists the bottom cover plate of the connector 27. An assembly gap is formed between the cover peripheral wall and the upper peripheral flank 2131, for assembling the members of the ventilation assembly 3′.

The ventilation assembly 3′ includes a ventilation tube 31, a blocking plate 37, an upper cover 33, and an airflow regulating structure 34. The ventilation tube 31 is installed in the liquid storage tube 12 and is sleeved on the atomizing seat 26. A liquid storage space is formed between the periphery of the ventilation tube 31 and the inner side of the liquid storage tube 12. An end of the ventilation tube 31 which is sleeved on the atomizing seat 26 defines a second clamping groove, for clamping the heating sheet 221 which extends out from the first clamping groove and is wrapped by the liquid absorbing member 223. In the illustrated embodiment, the ventilation tube 31 extends into the assembling gap between the inner side of the cover peripheral wall of the connector 27 and the periphery of the upper peripheral flank 2131, and resists the lower peripheral flank 214. The ventilation tube 31 forms external threads on the circumferential surface of the end extending into the assembling gap, the external threads engage the internal threads of the connector 27, thereby stably connecting the ventilation tube 31 to the atomizing seat 26. The second clamping groove of the ventilation tube 31 clamps the heating sheet 221 wrapped by the liquid absorbing member 223. The blocking plate 37 is connected to the upper end of the heating sheet 22. A width of the blocking plate and a width of the heating sheet 221 are equal to an inner diameter of the ventilation tube 31, the blocking plate 37 and the heating sheet 221 are arranged in a plane. Therefore, the blocking plate 37 and the heating sheet 221 divide the inner of the ventilation tube 31 into two conductive spaces 3211, the oriented gap is located in corresponding conductive space 3211, the two conductive spaces 3211 are fluidly communicated with each other at the lower end of the heating sheet 221. Further, the ventilation tube 31 defines an intake hole 311 at a tubular wall of the upper end of the ventilation tube 31. The intake hole 311 is merely defined on the tubular wall of one of the two conductive spaces 3211. An upper end of the conductive space 3211 which is fluidly communicated with the intake hole 311 is sealed. In the illustrated embodiment, a silica gel pad 36 is positioned to seal the upper end of the conductive space 3211, such that, when airflow enters the intake hole 311, the airflow flows through the conductive space 3211 on a side, and bypasses the heating sheet 221, and then the airflow flows out from the upper end of the conductive space 3211 on an opposite side (the airflow direction is shown as the arrow in FIG. 3).

The upper cover 38 is attached to the upper end of the ventilation tube 31. The upper cover 38 defines a sleeve hole 331 at a lower surface of the upper cover 38, and the upper cover 38 is sleeved on the upper end of the ventilation tube 31, the upper cover 38 defines a smog guiding hole 332 fluidly communicating with the sleeve hole 331. A circumferential surface of the upper cover 38 defines threads, configured to engage the airflow regulating structure 34.

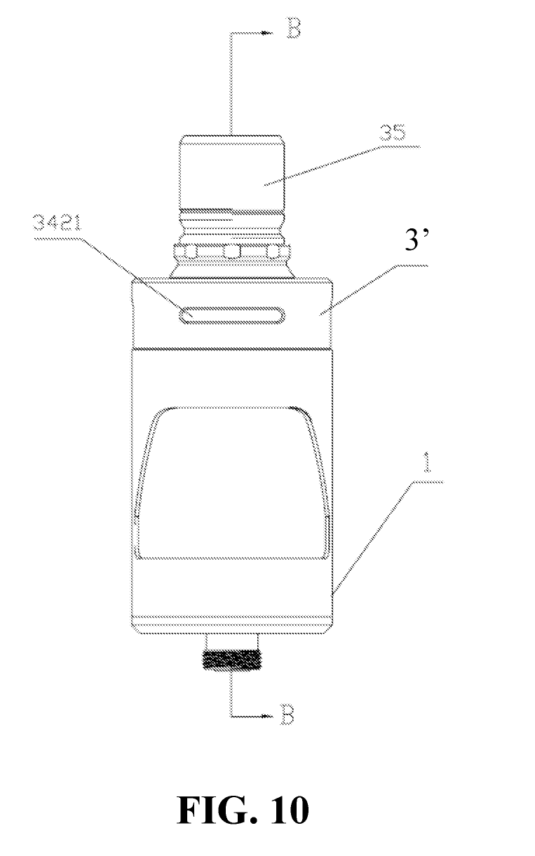

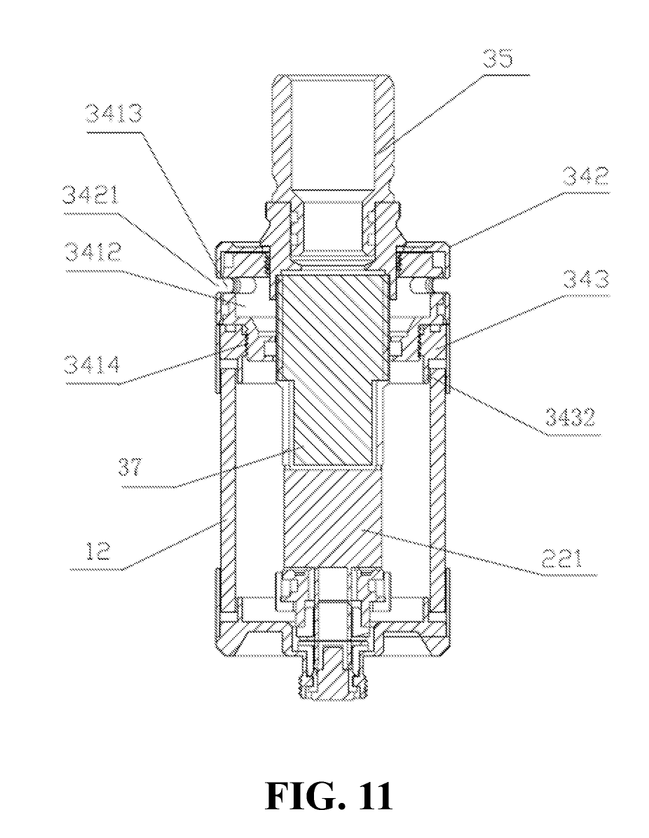

Referring to FIG. 10 and FIG. 11, the airflow regulating structure 34 is positioned on the upper end of the liquid storage tube 12. The airflow regulating structure 34 defines an intake cutout 3421 fluidly communicate with the intake hole 311. The airflow regulating structure 34 includes an inner annular seat 341, an airflow regulating ring 342, and a connecting seat 3432. The airflow regulating ring 342 is movably sleeved on a periphery of the inner annular seat 341. The connecting seat 3432 is fixedly connected to the upper end of the liquid storage tube 12, the inner annular seat 341 is detachably connected to the connecting seat 3432. The inner annular seat 241 includes an annular wall, a center of the annular wall defines a through hole, the ventilation tube 31 extends through the through hole and engages the upper cover 38 by an interference fit. An upper end of the inner peripheral surface of the annular wall defines upper threads 3411, for engaging the threads on the circumferential surface of the upper cover 38. The annular wall defines an annular groove 3412 at a middle portion of the inner peripheral surface of the annular wall. The annular groove 3412 fluidly communicates with the intake hole 311. The annular wall defines a plurality of ventilation holes 3413 at a circumferential surface, and the plurality of ventilation holes 3413 fluidly communicates with the annular groove 3412. The annular wall defines lower threads 3414 at a lower end of the circumferential surface of the annular wall. The airflow regulating ring 342 is rotatably sleeved on a periphery of the inner annular seat 341. The airflow regulating ring 342 defines an intake cutout 3421 at a peripheral wall of the airflow regulating ring 342. When the airflow regulating ring 342 is rotated, the communication area between the intake cutout 3421 of the airflow regulating ring 342 and the ventilation hole 3413 of the inner annular seat 341 is changed, thereby the air inflow can be adjusted. It can be understood that, the airflow regulating ring 342 can be movably sleeved on the inner annular seat 341 and can move upward and downward, thus when the airflow regulating ring 342 is moved upward and downward, the communication area between the intake cutout 3421 and the ventilation hole 3413 of the inner annular seat 341 is changed, thereby the air inflow is adjusted. Compared to the rotary type, the upward and downward moving type is suitable for many airflow regulating rings 342 which have different structures, for example, a change of a communication area of a prismatic or a triangular atomizing head can be achieved by the upward and downward moving type. Further, the inner annular seat 341 is provided with a limiting post (not shown) protruding from a circumferential surface of the inner annular seat 341. The limiting post extends through the intake cutout 3421 of the airflow regulating ring 342, such that the rotation route of the airflow regulating ring 342 can be limited. The connecting seat 3432 is configured to connect the inner annular seat 341 to the upper end of the liquid storage tube 12, for improving the air-tightness of the liquid storage tube 12. Specifically, the connecting seat 3432 defines a stepped groove at the circumferential surface of the lower end of the connecting seat 3432, and the lower end of the connecting seat 3432 is provided a protruding flange 3431 accordingly. The protruding flange 3431 extends into the liquid storage tube 12. The stepped groove engages with the upper end of the liquid storage tube 12 (as shown in the accompanying drawing, a sealing ring is provided at the upper end surface of the liquid storage tube 12 and is located in the stepped groove). The connecting seat 3432 defines threads on the inner peripheral surface of the connecting seat 3432, the threads on the inner peripheral surface of the connecting seat 3432 engage the lower threads 3414 on the lower end of the circumferential surface of the inner annular seat 341, such that by a configuration of the connecting seat 3432, an air-tightness of the connection between the inner annular seat 341 and the upper end of the liquid storage tube 12 is improved. It can be understood that, the connecting seat 3432 can be omitted, the inner annular seat 341 is directly connected to the liquid storage tube 12. In the embodiment, the connecting seat 3432 is made of rubber.

After the airflow regulating structure 34 is attached to the upper end of the liquid storage tube 12, the lower end of the through hole of the inner annular seat 341 is sleeved on and closely contacts the upper end of the ventilation tube 31 (a diameter of the lower end of the through hole of the annular wall is equal to a diameter of the upper end of the ventilation tube 31). The annular groove 3412 of the inner annular seat 341 is aligned to and fluidly communicates with the intake hole 311 of the ventilation tube 31, the smog guiding hole 332 of the upper cover 38 fluidly communicates with the upper end of the conductive space 3211 which is not closed.

The atomizer further includes a mouth piece 35, the mouth piece 35 is installed in the smog guiding hole 332 on the upper surface of the upper cover 38, for sucking the smog flowing out from the upper end of the conductive space 3211.

When user sucks the mouth piece 35, the liquid storage chamber storages tobacco liquid, because the liquid absorbing member 223 extends through the second clamping groove and contacts the tobacco liquid, the liquid absorbing member 223 wrapping the periphery of the heating sheet 221 contains the tobacco liquid by immersing. The airflow flows into the annular groove 3412 through the communicating portion between the intake cutout 3421 and the ventilation hole 3413. The airflow flows through the intake hole 311 of the ventilation tube 31 from the annular groove 3412 and enters into the conductive space 3211 at a side, the airflow in the conductive space 3211 bypasses the heating sheet 221 and enters into the conductive space 3211 on the opposite side. The airflow flows into the mouth piece 35 finally. Specifically, when the airflow bypasses the heating sheet 221, the airflow enters the oriented gap between the heating sheet 221 and one clamping peripheral wall 2111 on a side, and then bypasses the conductive pin 2221, and then the airflow enters the oriented gap between the heating sheet 221 and the clamping peripheral wall 2111 on an opposite side. Such that, opposite sides of the heating sheet 221 are provided with oriented gaps by a configuration of two clamping peripheral wall 2111, causing the airflow to flow through the heating sheet 221 closely, thus a heating efficiency of the airflow can be enchanted. It can be understood that, the clamping peripheral walls 2111 can be omitted. By virtue of rotating the airflow regulating ring 342, the communication area between the intake cutout 3421 of the airflow regulating ring 342 and the ventilation hole 3413 of the inner annular seat 341 is changed, thereby the air inflow is adjusted. When the tobacco liquid is not filled in the liquid storage chamber in time or the tobacco liquid is insufficient, because the heating sheet 221 is a ceramic heating sheet, the tobacco liquid in the liquid storage chamber can be absorbed by cotton or cotton cloth and be transferred to the ceramic heating sheet. The ceramic heating sheet can be a porous ceramic, such that the ceramic heating sheet can store some tobacco liquid, avoiding affecting user's flavor due to a dry-ashing. Compared to the metallic heating filament, it is difficult for the ceramic heating sheet to generate a peculiar smell due to a dry-ashing, when a dry-ashing of the metallic filament occurs, a peculiar smell in the using procedure can seriously influence the flavor of the user.

In conclusion, in the atomizer of the present disclosure, the heating sheet 221 is positioned on the lower end of the ventilation tube 31. When smoking, the airflow bypasses the heating sheet 221, the airflow flows fluently, and the smoke flavor cannot be affected. Further, by adopting the ceramic heating sheet to replace the related metallic winding heating filament, the situation of the peculiar smell generated by a dry-ashing of the metallic filament can be avoided. In addition, the atomizing assembly and the ventilation assembly 3′ are integrally assembled, and are integrally assembled to the liquid storage assembly 1. When the atomizer is dismantled, the atomizing assembly and the ventilation assembly 3′ are integrally separated from the liquid storage assembly, it facilitates for an injection of the tobacco liquid. Further, the atomizer adopts an upper air intake type and an upper airflow regulating mode, thus the tobacco liquid leaking out of the atomizer from the inhale passage due to a lower air intake type can be avoided, the user experience and appearance cannot be influenced.

Furthermore, the present disclosure provides an electronic cigarette having aforementioned atomizer. The electronic cigarette includes a battery assembly disposed about the lower end of the atomizer. The battery assembly is located on the lower end of the liquid storage assembly 1 and is electrically connected to the electrode contacting assembly 13. When the electronic cigarette is used, the battery assembly supplies power for the atomizer, the user smokes through the mouth piece 35.

The embodiments described above are merely preferred embodiments, but not intended to limit the application. Any modifications, alternatives or improvements made within the principle and spirit of the present application should be interpreted as falling within the protection scope of the present application.

1. An atomizing head, comprising:
a main body seat comprising a cylindrical portion defining a pair of slots on opposite sides of the cylindrical portion; and
a heating member comprising a heating sheet;
wherein the heating sheet is installed in the cylindrical portion and is clamped in the pair of slots, the heating sheet divides the cylindrical portion into two first atomizing spaces which are opposite to each other.

2. The atomizing head according to claim 1, further comprising an external sleeve, wherein the external sleeve is sleeved on a periphery of the cylindrical tube, a tubular wall of the external sleeve tube defines a liquid hole, and a gap is formed between an inner peripheral surface of the external sleeve and a circumferential surface of the cylindrical portion, the tobacco liquid flows through the liquid hole and enters into the gap.

3. The atomizing head according to claim 2, wherein the heating sheet is a ceramic heating sheet, the heating sheet is wrapped by a liquid absorbing member and is then clamped by and installed in the cylindrical portion, the liquid absorbing member extends to the gap from the pair of slots on opposite sides of the cylindrical portion.

4. The atomizing head according to claim 3, further comprising an electrode conductor and an insulator, wherein the main body seat further comprises a bottom wall and a tubular portion, the bottom wall is formed on a lower end of the cylindrical portion, the tubular portion is formed an end of the bottom wall away from the cylindrical portion, the tubular portion extends through the bottom wall and fluidly communicates with the cylindrical portion, and the heating sheet further comprises two leading pins connected to the heating sheet, the electrode conductor is installed in the tubular portion, and is insulated from a tubular wall of the tubular portion via the insulator ring, one of the two leading pins is electrically connected to the electrode conductor, another one of the two leading pins is electrically connected to the tubular wall of the tubular portion.

5. An atomizer, comprising an atomizing head according to claim 1 and an airflow regulating assembly.

6. The atomizer according to claim 5, wherein the airflow regulating assembly comprises a ventilation tube and an isolator sheet installed in the ventilation tube, the isolator sheet divides the ventilation tube into two second atomizing spaces, an upper end of the ventilation tube defines an intake hole, a lower end of the ventilation tube is aligned to the cylindrical portion of the main body seat, the two second atomizing spaces fluidly communicate with two corresponding first atomizing spaces respectively to form two airflow passages, the two first atomizing spaces are located beneath the two second atomizing spaces, and the two airflow passages fluidly communicate with each other at a lower end of the heating sheet, one of the two airflow passages fluidly communicates with the intake hole, and is closed at an upper end thereof, such that when airflow enters the intake hole, the airflow flows through the airflow passage on a side, and bypasses the heating sheet, and then flows out from an upper end of the conductive space on an opposite side.

7. The atomizer according to claim 6, wherein the airflow regulating assembly further comprises a rotation ring, an end of the rotation ring is connected to the ventilation tube, an opposite end of the rotation ring is detachably connected to the atomizing head.

8. The atomizer according to claim 6, further comprising a mouth piece connector which is disposed about an upper end of the ventilation tube, wherein a lower surface of the mouth piece connector defines a sleeve hole which is sleeved on the upper end of ventilation tube, a center of an upper surface of the mouth piece connector defines a smog guiding hole which is fluidly communicated with the sleeve hole.

9. The atomizer according to claim 6, wherein the airflow regulating assembly further comprises an airflow regulating structure, the airflow regulating structure comprises an inner annular seat and an airflow regulating ring, the inner annular seat comprises an annular wall, the annular wall defines an annular groove at a middle portion of an inner peripheral surface thereof to fluidly communicate with the intake hole, the annular wall defines a plurality of ventilation holes at a circumferential surface thereof which are fluidly communicated with the annular groove, and the airflow regulating ring is rotatably sleeved on the inner annular seat, a peripheral wall of the airflow regulating ring defines an intake cutout, when the airflow regulating ring is rotated, a communication area between the intake cutout and the ventilation hole is adjusted.

10. The atomizer according to claim 9, wherein the airflow regulating structure further comprises an inner connector, the annular wall defines lower threads at a lower end of a circumferential surface of the annular wall, the inner surface of the inner connector defines threads engaging the lower threads.

11. An atomizer, comprising an atomizing assembly and a ventilation assembly; wherein the atomizing assembly comprises an atomizing seat and a heating assembly, the heating assembly comprises a heating sheet clamped by the atomizing seat, the ventilation assembly comprises a ventilation tube and a blocking plate, the ventilation tube is sleeved on the atomizing seat and the heating sheet, the blocking plate is connected to an upper end of the heating sheet to cooperatively divide the ventilation tube into two conductive spaces which are fluidly communicated with each other at a lower end of the heating sheet, the ventilation tube defines an intake hole at a tubular wall thereof fluidly communicating with one of the two conductive spaces which is sealed at an upper end, such that, airflow enters one of the two conductive spaces at a side of the ventilation tube via the intake hole, and bypasses the heating sheet, and then the airflow flows out from the upper end of the conductive space on an opposite side.

12. The atomizer according to claim 11, wherein the atomizing seat defines a first clamping groove along an axial direction of the atomizing seat, and forms a pair of clamping peripheral walls accordingly, the pair of clamping peripheral walls is opposite to each other, the heating assembly further comprises a liquid absorbing member wrapping the heating sheet, the heating sheet along with the liquid absorbing member are clamped by and n in the first clamping groove, and extend outwardly from the first clamping groove.

13. The atomizer according to claim 12, wherein the ventilation tube defines a second clamping groove along an axial direction of the ventilation tube, for clamping the heating sheet which is wrapped by the liquid absorbing member and extends out from the first clamping groove.

14. The atomizer according to claim 12, wherein the heating assembly further comprises two conductive pins connected to a lower end of the heating sheet, the heating sheet and the two clamping peripheral walls form two oriented gaps, each oriented gap is formed between the heating sheet and one of the two clamping peripheral walls, the conductive pin allows airflow to flow there-through, causing the two oriented gaps on opposite sides of the heating sheet to fluidly communicate with each other, the oriented gap is received in corresponding conductive space, causing the two conductive spaces on opposite sides of the heating sheet to fluidly communicate with each other at the lower end of the heating sheet.

15. The atomizer according to claim 11, wherein the ventilation assembly further comprises an upper cover disposed about the upper end of the ventilation tube, a lower surface of the upper cover defines a sleeve hole which is sleeved on the upper end of the ventilation tube, a center of an upper surface of the upper cover defines a smog guiding hole fluidly communicated with the sleeve hole.

16. The atomizer according to claim 11, wherein the ventilation assembly comprises an airflow regulating structure, the airflow regulating structure comprises an inner annular seat and an airflow regulating ring, the airflow regulating ring is movably sleeved on a circumference of the inner annular seat, the inner annular seat comprises an annular wall, the annular wall defines an annular groove at a middle portion of an inner peripheral surface thereof to fluidly communicate with the intake hole, the annular wall defines a plurality of ventilation holes at a circumferential surface thereof, the plurality of ventilation holes fluidly communicate with the annular groove, a peripheral wall of the airflow regulating ring defines an intake cutout, when the airflow regulating ring is rotated, a communication area between the intake cutout and the ventilation hole is adjusted.

17. The atomizer according to claim 11, wherein an end of the atomizing seat away from the heating sheet is a connecting end, the connecting end comprises a cylindrical tubular portion, an upper peripheral flank, and a lower peripheral flank, the upper peripheral flank and the lower peripheral flank are formed on a periphery of the cylindrical tubular portion and are spaced from each other, a lateral length of the lower peripheral flank is greater than a lateral length of the upper peripheral flank, the atomizing assembly further comprises a connector, the connector comprises a cover bottom plate and a cover peripheral wall formed on a periphery of the cover bottom plate, the cover bottom plate defines a perforation on a center thereof, the connector extends through the perforation upwardly and is sleeved on the connecting end, an assembly gap is formed between an inner side of the cover peripheral wall and an upper side of the upper peripheral flank, for assembling the ventilation tube.

18. The atomizer according to claim 11, wherein a silica gel pad is positioned to seal the upper end of the conductive space which fluidly communicates with the intake hole.

19. The atomizer according to claim 11, wherein the heating sheet is a ceramic heating sheet.
